(19) United States
(12) Patent Application Publication
(10) Pub. No.: US 2005/0271348 A1
(43) Pub. Date: Dec. 8, 2005

(54) Prism sheet for a backlight module

(76) Inventor: Hsin-Hsin Huang Hsu, Tainan Hsien (TW)

Correspondence Address: ROSENBERG, KLEIN & LEE, 3458 ELLICOTT CENTER DRIVE-SUITE 101, ELLICOTT CITY, MD, 21043, US

(21) Appl. No.: 10/857,865

(22) Filed: Jun. 2, 2004

(51) Int. Cl. G02B 6/10

(52) U.S. Cl. 385/146; 385/901

(57) ABSTRACT

A prism sheet for a backlight module includes a substrate, multiple parallel microstructure prisms and multiple elongated protrusions. The substrate has a first surface on which the parallel prisms are formed. Each of the prisms has a first facet, a second facet and an axis. The elongated protrusions are formed on at least one of the first and the second facets along the axis of each prism and may be shaped into curved or polygonal. Consequently, the elongated protrusions will provide increases of light refraction, refract the light into multiple directions and aid the entire prism sheet to efficiently distribute the refracted light to provide sufficient incident light transmitted into liquid crystal display panels.

### BACKGROUND OF THE INVENTION

1. Field of the Invention

The present invention relates to a prism sheet for a backlight module, and more particularly to a high optical performance prism sheet for a backlight module in a liquid crystal display (LCD) to enhance brightness of the liquid crystal display.

2. Description of Related Art

Liquid crystal displays have become popular in the recent years. A liquid crystal display generally comprises a liquid crystal display panel and a backlight module. The liquid crystal display panel contains the liquid crystal, but cannot produce light by itself.

The backlight module produces light for the liquid crystal display panel and comprises typically light sources, light guides, diffusers, reflective sheets, microstructure prism sheets etc. The light sources such as fluorescent lamps produce light, and the light is reflected by the reflective sheets. The reflected light is redirected by the light guides to pass through the diffusers. The prism sheet, also called “brightness enhancement film” is mounted between the diffusers and the liquid crystal display panel and collimates the light emitted by the diffusers to the liquid crystal display panel. The prism sheet transmits the light into the liquid crystal display panel to produce brightness of the liquid crystal display panel. The incident light for the liquid crystal display panel will cause the liquid crystal display to become clearly visible.

With reference to FIG. 8, a conventional prism sheet (20) for a backlight module in accordance with the prior art comprises a substrate (21) and multiple microstructure prisms (22). The substrate (21) has a top surface. The prisms (22) are integrally formed on the top surface of the substrate (21) and are parallel with one another. Each of the prisms (22) has two facets (23).

The light produced by the light source enters the prism sheet (20) through the light guides and the diffusers and is refracted and dispersed by the prisms (22) into the liquid crystal display panel. Therefore, the prism sheet (20) provides uniform incident light to illuminate the liquid crystal display panel.

However, both the facets (23) of each prism (22) are flat surfaces. Each of the flat facets (23) only can refract the light into a single direction. The refraction of the light by one single facet (23) is one dimensional so that the entire prism sheet (20) will not efficiently distribute the light into the liquid crystal display panel. Using the conventional prism sheet (20) will cause insufficient brightness of the liquid crystal display.

To overcome the shortcomings, the present invention provides an improved prism sheet for a backlight module that will efficiently distribute light for a liquid crystal display panel to mitigate or obviate the aforementioned problems.

### SUMMARY OF THE INVENTION

The main objective of the invention is to provide an improved prism sheet for a backlight module and the prism sheet has multiple microstructure prisms and multiple elongated protrusions formed on the prisms to increase refracting areas of the prisms and brightness of a liquid crystal display panel.

A prism sheet for a backlight in accordance with the present invention includes a substrate, multiple parallel microstructure prisms and multiple elongated protrusions. The substrate has a first surface on which the parallel prisms are formed. Each of the prisms has a first facet, a second facet and an axis. The elongated protrusions are formed on at least one of the first and the second facets along the axis of each prism and may be shaped into a curved or polygonal figure. Consequently, the elongated protrusions will increase an area of light refraction, refract the light into multiple directions and aid the entire prism sheet to efficiently distribute the refracted light to provide sufficient incident light transmitted into a liquid crystal display panel.

Other objectives, advantages and novel features of the invention will become more apparent from the following detailed description when taken in conjunction with the accompanying drawings.

### BRIEF DESCRIPTION OF THE DRAWINGS

FIG. 1 is a perspective view of a first embodiment of a prism sheet for a backlight module in accordance with the present invention;

FIG. 2 is an enlarged elevational view of a segment of the prism sheet in FIG. 1;

FIG. 3 is an enlarged elevational view of an alternative configuration of multiple elongated protrusions of the segment of the prism sheet in FIG. 2;

FIG. 4 is a perspective view of a second embodiment of a prism sheet for a backlight module in accordance with the present invention;

FIG. 5 is an enlarged elevational view of a segment of the prism sheet in FIG. 4;

FIG. 6 is an enlarged elevational view of an alternative configuration of multiple elongated protrusions of the segment of the prism sheet in FIG. 5;

FIG. 7 is an enlarged elevational view of a segment of a third embodiment of a prism sheet for a backlight module in accordance with the present invention; and

FIG. 8 is a perspective view of a conventional prism sheet for a backlight module in accordance with prior art.

### DETAILED DESCRIPTION OF PREFERRED EMBODIMENT

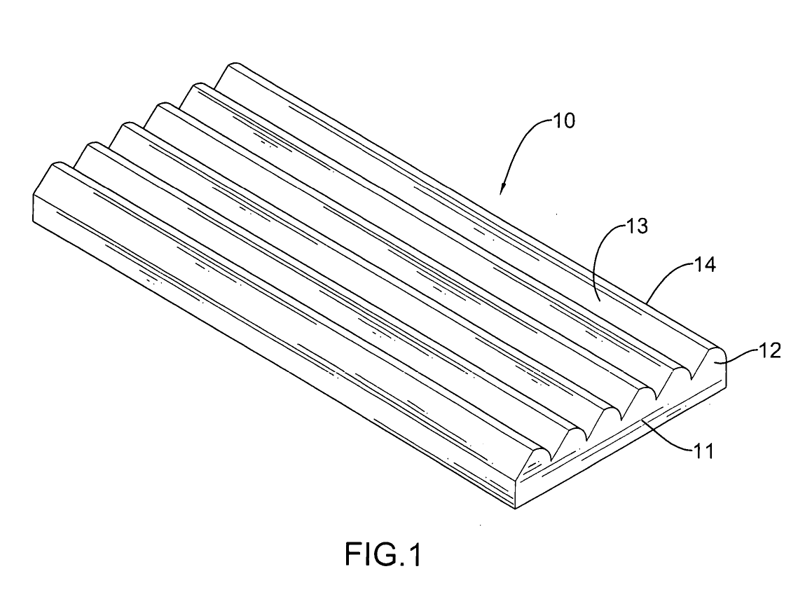

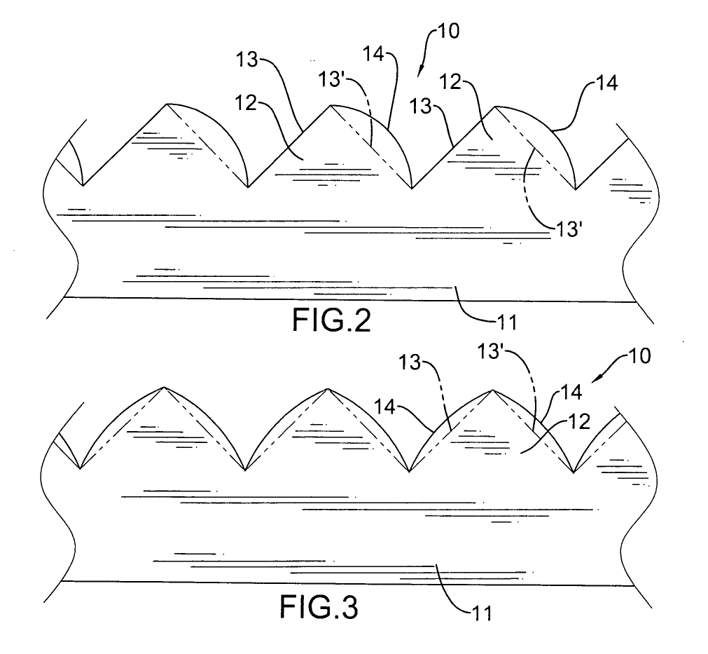

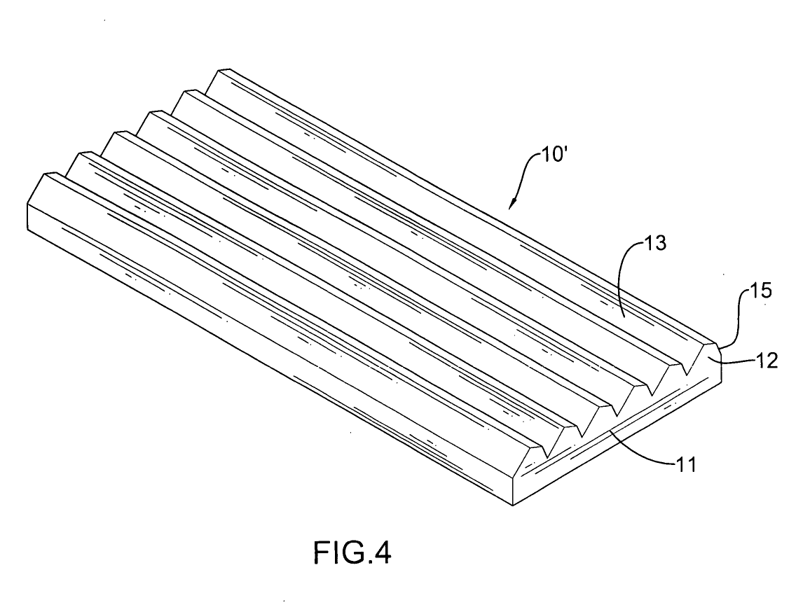

With reference to FIGS. 1, 2 and 3, a first embodiment of a prism sheet (10) for a backlight module in accordance with the present invention comprises a substrate (11), multiple microstructure prisms (12) and multiple elongated protrusions (14).

The substrate (11) has a first surface and a second surface and is made of transparent materials, such as polyester or polycarbonate. The second surface is opposite to the first surface and may be a planar or flat surface.

The prisms (12) collimate light emitted through the substrate (11) into a liquid crystal display panel, are integrally formed on the first surface of the substrate (11) and are parallel with one another. Each of the prisms (12) has a first facet (13), a second facet (13′) and an axis.

Elongated protrusions (14) are integrally formed on either both or one of the facets (13, 13′) along the axis of the corresponding prism (12). Each of the elongated protrusions (14) has a curved cross section when viewing the axis of the corresponding prism (12).

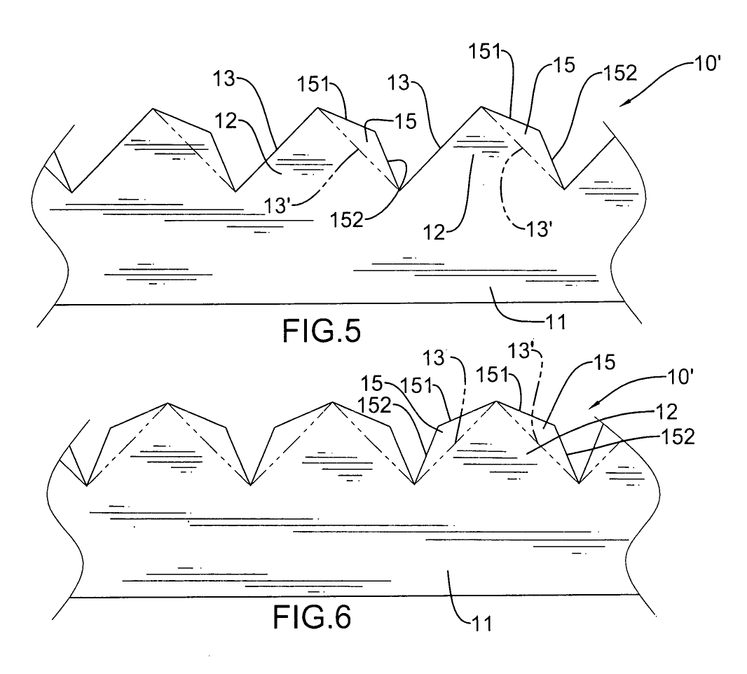

With reference to FIGS. 4, 5 and 6, a second embodiment of a prism sheet (10′) in accordance with the present invention modifies the first embodiment of the present invention. The modifications are implemented with multiple modified elongated protrusions (15). The elongated protrusions (15) are integrally formed on either both or one of the facets (13, 13′) along the axis of the corresponding prism (13). Each of the elongated protrusions (15) has a polygonal cross section when viewing the axis of the corresponding prism (12). The polygonal elongated protrusions (15) can be triangular. Each of the elongated protrusions (15) has a first inclined surface (151) and a second inclined surface (152).

Each of the first and the second inclined surfaces (151, 152) faces outward and has a width. The width of the first inclined surface (151) may be greater than, equal to or less than the width of the second inclined surface (152).

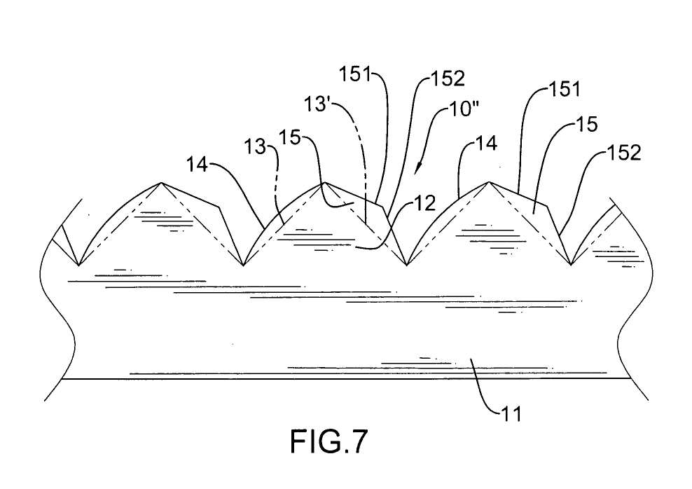

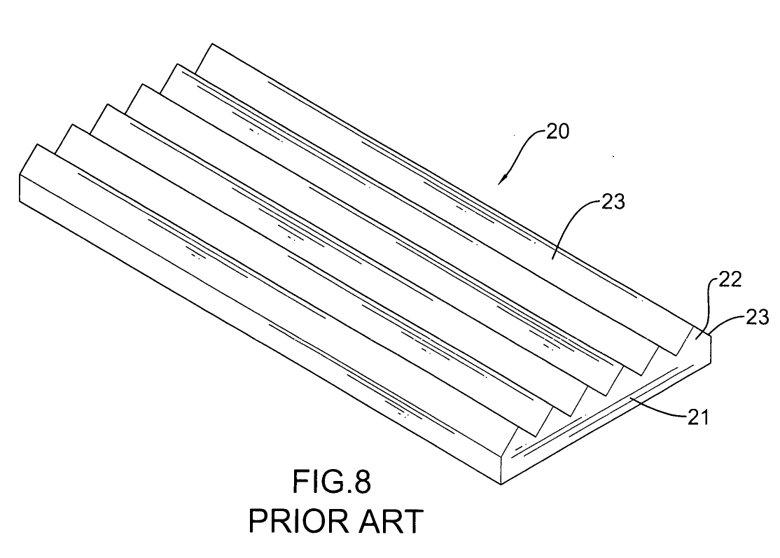

With reference to FIG. 7 a third embodiment of a prism sheet (10″) in accordance with the present invention is a modification of incorporating the features of the elongated protrusions (14, 15) of the first and the second embodiments as previously described.

The curved elongated protrusions (14) are integrally and respectively formed on the first facets (13) of the prisms (12). The polygonal elongated protrusions (15) are integrally and respectively formed on the second facets (13′) of the prisms (12).

Each of the first and the second inclined surfaces (151, 152) faces outward and has a width. The width of the first inclined surface (151) may be greater than, equal to or less than the width of the second inclined surface (152).

Consequently, the elongated protrusions (14, 15) either shaped into a curved or a polygonal figure will increase an area of light refraction and refract the light into multiple directions. The elongated protrusions (14, 15) will also aid the entire prism sheets (10, 10′) to efficiently distribute the refracted light to provide sufficient incident light transmitted into the liquid crystal display panels.

Even though numerous characteristics and advantages of the present invention have been set forth in the foregoing description, together with details of the structure and function of the invention, the disclosure is illustrative only, and changes may be made in detail, especially in matters of shape, size, and arrangement of parts within the scope of the appended claims.

1. A prism sheet for a backlight module, and the prism sheet comprising:
a substrate having a first surface and a second surface opposite to the first surface;
multiple parallel microstructure prisms integrally formed on the first surface of the substrate, and each of the microstructure prisms having a first facet, a second facet and an axis; and
multiple elongated protrusions integrally formed on at least one of the first and the second facets of the microstructure prisms along the axis of each of the microstructure prisms.

2. The prism sheet for a backlight module as claimed in claim 1, wherein each of the elongated protrusions has a curved cross section when viewing the axis of the corresponding elongated protrusion, and the elongated protrusions are respectively formed on the second facets of the microstructure prisms.

3. The prism sheet for a backlight module as claimed in claim 1, wherein each of the elongated protrusions has a curved cross section when viewing the axis of the corresponding elongated protrusion, and the elongated protrusions are respectively formed on both the first and the second facets of the microstructure prisms.

4. The prism sheet for a backlight module as claimed in claim 1, wherein each of the elongated protrusions has a polygonal cross section when viewing the axis of the corresponding elongated protrusion, and the elongated protrusions are respectively formed on the second facets of the microstructure prisms.

5. The prism sheet for a backlight module as claimed in claim 1, wherein each of the elongated protrusions has a polygonal cross section when viewing the axis of the corresponding elongated protrusion, and the elongated protrusions are respectively formed on both the first and the second facets of the microstructure prisms.

6. The prism sheet for a backlight module as claimed in claim 1, wherein the elongated protrusions are respectively formed on both the first and the second facets of the microstructure prisms, each of the elongated protrusions on the first facets has a curved cross section when viewing the axis of the corresponding elongated protrusion and each of the elongated protrusions on the second facets has a polygonal cross section when viewing the axis of the corresponding elongated protrusion.

7. The prism sheet for a backlight module as claimed in claim 4, wherein the polygonal elongated protrusions are triangular, and each of the polygonal elongated protrusions has a first inclined surface and a second inclined surface.

8. The prism sheet for a backlight module as claimed in claim 5, wherein the polygonal elongated protrusions are triangular, and each of the polygonal elongated protrusions has a first inclined surface and a second inclined surface.

9. The prism sheet for a backlight module as claimed in claim 6, wherein the polygonal elongated protrusions are triangular, and each of the polygonal elongated protrusions has a first inclined surface and a second inclined surface.

10. The prism sheet for a backlight module as claimed in claim 9, wherein each of the first and the second inclined surfaces has a width, wherein the width of the first inclined surface is equal to the width of the second inclined surface.

11. The prism sheet for a backlight module as claimed in claim 1, wherein the second surface of the substrate is a flat.
